(19) United States
(12) Patent Application Publication
(10) Pub. No.: US 2002/0032619 A1
(43) Pub. Date: Mar. 14, 2002

(54) Method and system for selecting fuse configurations

(76) Inventors: Jose Luis Pozo, Barcelona (ES); Alex Lombardi, Marlborough, CT (US); David H. Merritt, Atlanta, GA (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,572

(22) Filed: May 1, 2001

Related U.S. Application Data
(60) Provisional application No. 60/200,869, filed on May 1, 2000.

(51) Int. Cl. G06F 17/60

(52) U.S. Cl. 705/27

(57) ABSTRACT

A web-based method for identifying fuses includes receiving fuse specification information from a user and utilizing a server to compare the received specification information with pre-stored information. The method also includes selecting at least one fuse which matches the received specification information and downloading to the user information related to the fuse.

### CROSS REFERENCE TO RELATED APPLICATIONS

This application claims the benefit of U.S. Provisional Application No. 60/200,869, filed May 1, 2000, which is hereby incorporated by reference in its entirety.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

This invention relates generally to computer network-based wizards and more particularly to a network-based method and system for identifying current-limiting fuse configurations and costs associated therewith.

Fuses generally are safety devices placed in-line in an electrical circuit to provide protection to the electrical circuit against overloading. A fuse typically has a fusible, i.e. meltable, element, typically of metal, enclosed in a protective casing that conducts electrical current flowing through the circuit. When power through the circuit exceeds a predetermined safe level, the fusible element melts and thereby causes a break in the electrical current.

Identifying a correct fuse for a specific application is not always an easy task. Many parameters should be considered, and each combination of parameters could demand a specific fuse for optimum performance.

Therefore, it would be desirable to quickly determine a proper fuse that should be utilized for different combinations of parameters. In addition, it would be desirable to determine if a particular fuse provides inadequate performance for equipment, machinery, or a facility.

### SUMMARY OF INVENTION

In an exemplary embodiment, a network-based method, implemented on a network-based system, for selecting a fuse includes receiving product specification information from a user and comparing the received product specification information with pre-stored fuse information. If at least one fuse matches the received product specification information, the pre-stored fuse information is downloaded for communication to the user.

The product information may include, for example, features of the product and accessories of the product. The system validates configuration compatibility based on product information data and features of the product to determine whether a resulting product is capable of desired performance for a set of given product parameters. In addition, the system provides a table of fuses that meets a received application.

### BRIEF DESCRIPTION OF DRAWINGS

FIG. 1 is a system block diagram.

FIG. 2 is an expanded version block diagram of a server architecture of a system in accordance with one embodiment of the present invention.

FIG. 3 is a flow diagram of a web-based method for selecting and ordering fuses.

FIG. 4 is an exemplary fuse family page.

FIG. 5 is an exemplary general purpose fuses product information page.

FIG. 6 is an exemplary capacitor fuses product information page.

FIG. 7 is an exemplary motor starter fuses product information page.

FIG. 8 is an exemplary parts online—fuses wizard entry point page.

FIG. 9 is an exemplary fuses quick search page.

FIG. 10 is an exemplary information request page.

FIG. 11 is an exemplary fuse wizard main page.

FIG. 12 is an exemplary output form page.

FIG. 13 is an exemplary application assistant page.

FIG. 14 is an exemplary manufacture cross reference page.

FIG. 15 is an exemplary support and disconnect switch selector page.

FIG. 16 is an exemplary fuse accessories page.

FIG. 17 is an exemplary guidance message page.

FIG. 18 is an exemplary live parts selector page.

FIG. 19 is an exemplary live parts selector page.

### DETAILED DESCRIPTION

Set forth below is a description of exemplary methods and systems for facilitating a fuse selection. In one exemplary embodiment of a system to facilitate the selection of a fuse for a particular application, a user logs into the system and the system prompts the user, e.g., via a display that prompts the user for inputs, to enter information relating to particulars of the fuse. Once the user inputs information pertaining to a particular fuse application, the system then obtains, e.g., via a display that prompts the user for inputs, additional information based on the application. The particular information obtained by the system is determined by the particular application of the fuse. Once the requested information is received by the system, the system recommends a specific fuse for the particular application.

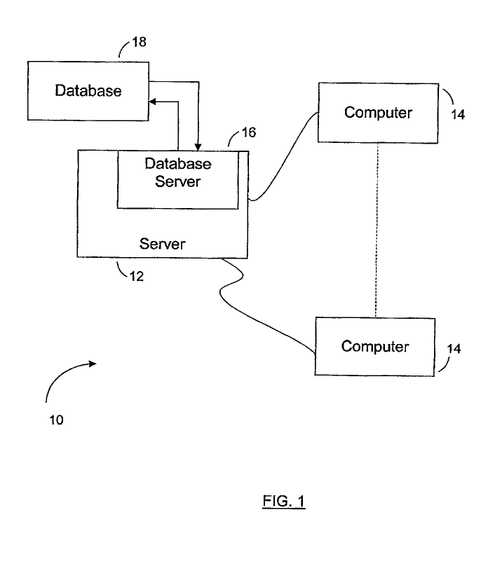

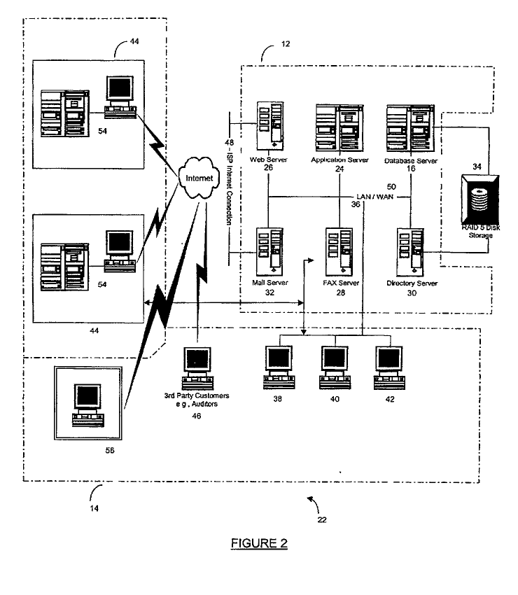

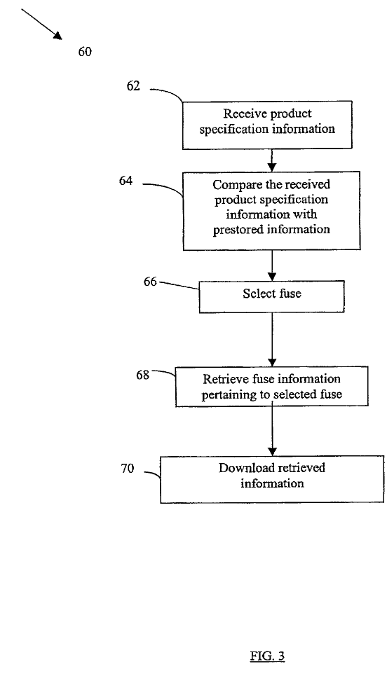

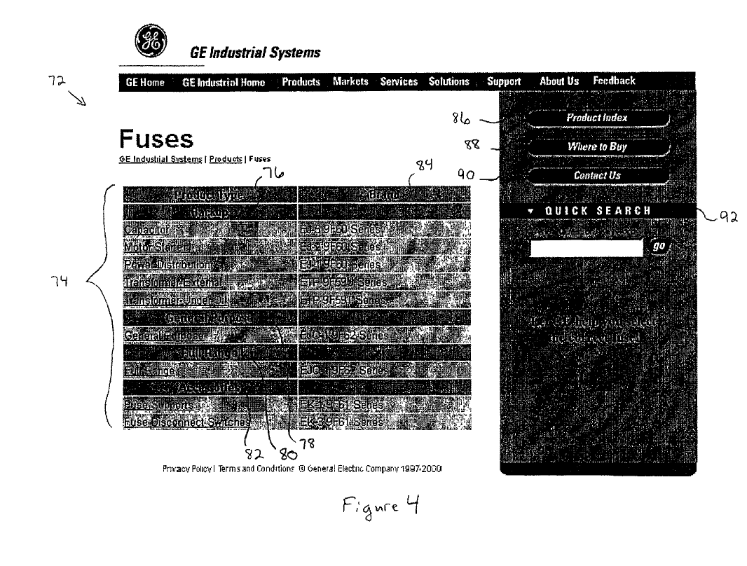

Set forth below are details regarding exemplary hardware architectures (FIGS. 1 and 2), an exemplary process flow chart illustrating processing for various types of applications (FIG. 3), and exemplary screen shots displayed by the exemplary system to a user desiring a fuse (FIGS. 4-19). Although specific exemplary embodiments of methods and systems for selecting fuses are described herein, the methods and systems are not limited to such specific exemplary embodiments.

FIG. 1 is a block diagram of a fuse selection system 10 in accordance with one embodiment of the present invention. System 10 includes a server sub-system 12 and a plurality of user devices 14 connected to server sub-system 12, sometimes referred to herein as server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a web-based phone or other web-based connectable equipment. Server sub-system 12 includes a database server 16 connected to a centralized database 18 containing fuse information, as described below in greater detail. In one embodiment, centralized database 18 is stored on database server 16 and can be accessed by potential users at one of user devices 14 by logging onto server sub-system 12 through one of user devices 14. In an alternative embodiment centralized database 18 is stored remotely from server sub-system 12.

FIG. 2 is an expanded version block diagram of an exemplary embodiment of a server architecture of a fuse selection system 22. Components of system 22, identical to components of system 10 (shown in FIG. 1), are identified in FIG. 2 using the same reference numerals as used in FIG. 1. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to users 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any authorized individual or an employee of the business entity having a workstation 52 can access server sub-system 12. One of user devices 14 includes a senior manager's workstation 54 located at a remote location. Workstations 52 and 54 are personal computers having a web browser. Also, workstations 52 and 54 are configured to communicate with server subsystem 12. Furthermore, fax server 28 communicates with employees located outside the business entity and any of the remotely located user systems, including a user system 56 via a telephone link. Fax server 28 is configured to communicate with other workstations 38, 40, and 42 as well.

FIG. 3 is a flow diagram 60 for a web-based method for selecting and ordering fuses. In one embodiment, the fuses are medium voltage current limiting fuses. In an alternative embodiment, the fuses are medium voltage expulsion fuses. In a further alternative embodiment, the fuses are low voltage fuses. System 10 (shown in FIG. 1) receives 62 product specification information from a user. In one embodiment, the user inputs the information into a device (such as device 14 shown in FIG. 1) which transmits the information to a server (such as server 12 shown in FIG. 1). The product specification information is received from the user via a graphical user interface as will be described in greater detail below.

The received product specification information includes an identification of fuse features and an identification of accessories for the product. Exemplary fuse features include, but are not limited to, catalog number, voltage, and current. Additional features include, but are not limited to, fuse support and disconnect switch.

Server 12 compares 64 the received information to pre-stored information accessible by server 12. In one embodiment, the pre-stored information is stored in a database that resides on server 12. In an alternative embodiment, the pre-stored information is stored in a database remote from server 12. The pre-stored information includes the fuse features and accessories information. Server 12 compares the received information to the pre-stored information to determine if any fuses contained in the pre-stored information satisfy the product specifications submitted by the user.

In addition, system 12 assesses the information supplied by the user to validate configuration compatibility of the product. Exemplary information includes product application, product parameters, desired product features, and product accessories. System 10 evaluates the information supplied by the user and determines whether a resulting product incorporating a fuse having the received product specifications is capable of meeting parameters of the indicated product. For example, system 10 determines whether accessories are available for the selected fuse configuration and, if the selected accessory is not available for the selected fuse configuration, system 10 displays a message to the user that the selected accessory is not available for the selected fuse configuration.

If the product resulting from the received information does not meet the parameters of the intended product, system 10 guides a user by providing suggestions for a correct product configuration. In an alternative embodiment, system 10 guides a user by providing information regarding alternative products compatible with the product parameters supplied by the user. In a further alternative embodiment, system 10 guides a user by providing information regarding products that are upgrades for the product parameters supplied by the user.

System 10 then identifies pre-stored fuse information that matches the information entered by the user and selects 66 those fuses pertaining to that pre-stored information. System 10 retrieves 68 fuse information pertaining to the selected fuse. In one embodiment, the fuse information includes a fuse identifier number and associated price for each selected fuse. For example, the fuse identifier number is a catalog number and the price is a list price of the product. Server 12 then transmits the retrieved fuse identifier number and associated price and downloads 70 the retrieved information to user device 14 so that the user can view the information. In an alternative embodiment, system 10 utilizes the list price information to generate a quotation for each selected fuse including the indicated features and accessories and server 12 then transmits the retrieved fuse identifier number and the quotation to user device 14.

System 10 then prompts the user to order one or more of the selected products. If the user is a registered user, system 10 accepts orders online by providing the user a purchase order form and receiving the completed purchase order form from the user. The completed purchase order form is then authenticated against pre-determined criteria to determine whether system 10 should accept the completed purchase order form. If the purchase order form is accepted, the ordered product is then shipped to the user.

If the user is an unregistered user, and the user attempts to order a selected product, system 10 transmits a notification to the user indicating that a sales person or an authorized distributor will contact the user to confirm the order request. System 10 then transmits a notification, such as via email, to a selected person. The selected person checks the order and instructs system 10 to transmit the order to a field sales regional manager or district manager. The field sales manager then follows-up with the lead or forwards the lead to a distributor with instructions to follow-up with the user that submitted the order.

FIGS. 4 through 19 detail navigation through an exemplary web-site linked to system 10 (shown in FIG. 1) via device 14 (shown in FIG. 1) and server 12 (shown in FIG. 1). For example, FIG. 4 is an exemplary fuse family page 72 downloaded and displayed on device 14 by server 12 when a user decides to order, or obtain additional information, on fuses by selecting a fuse help area (not shown) or a solutions engine area (not shown) on a home page (not shown) of a business entity. Once either the fuse help area or the solutions engine area is selected by the user, system 10 downloads a further user interface (not shown in FIG. 4) onto user device 14.

Fuse family page 72 includes a listing 74 of backup fuses 76, general purpose fuses 78, full range fuses 80, fuse accessories 82, and brand 84. Page 72 also includes a product index button 86, a where to buy button 88, a contact us button 90 and a quick search area 92.

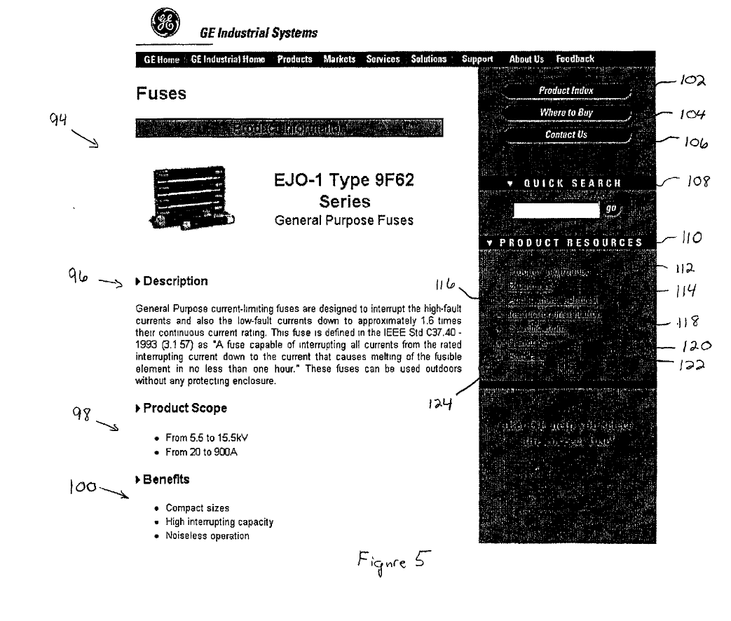

FIG. 5 is an exemplary general purpose fuses product information page 94 including a description section 96, a product scope section 98, and a benefits section 100. Description section 96 includes a brief definition of a general purpose current limiting fuse. Page 94 also includes a product index button 102, a where to buy button 104, a contact us button 106, and a quick search area 108. Page 94 further includes a product resources section 110 that includes listings such as product information 112, brochures 114, application/technical 116, instruction/installation 118, specifications 120, drawings 122, and software 124.

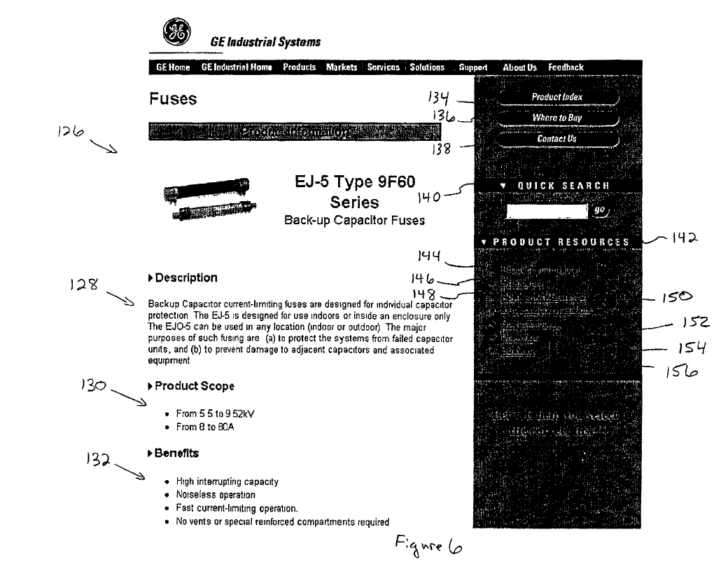

FIG. 6 is an exemplary capacitor fuses product information page 126 including a description section 128, a product scope section 130, and a benefits section 132. Description section 128 includes a brief definition of a capacitor fuse. Page 126 also includes a product index button 134, a where to buy button 136, a contact us button 138, and a quick search area 140. Page 126 further includes a product resources section 142 that includes listings such as product information 144, brochures 146, application/technical 148, instruction/installation 150, specifications 152, drawings 154, and software 156.

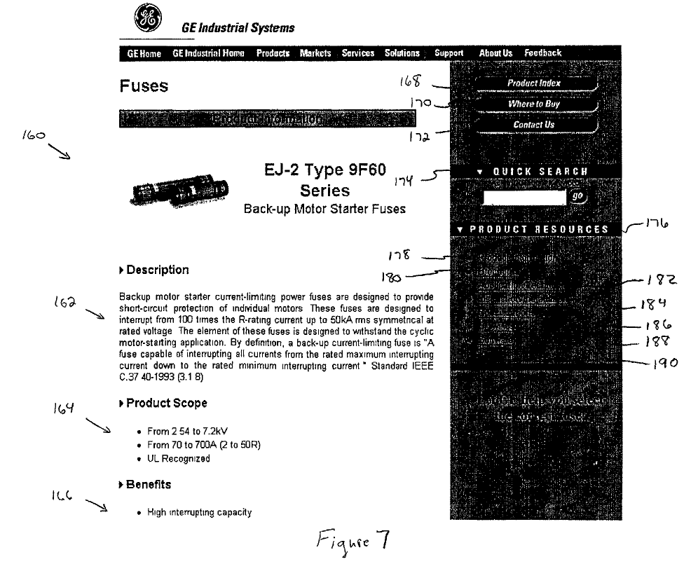

FIG. 7 is an exemplary motor starter fuses product information page 160 including a description section 162, a product scope section 164, and a benefits section 166. Description section 162 includes a brief definition of a capacitor fuse. Page 160 also includes a product index button 168, a where to buy button 170, a contact us button 172, and a quick search area 174. Page 160 further includes a product resources section 176 that includes listings such as product information 178, brochures 180, application/technical 182, instruction/installation 184, specifications 186, drawings 188, and software 190.

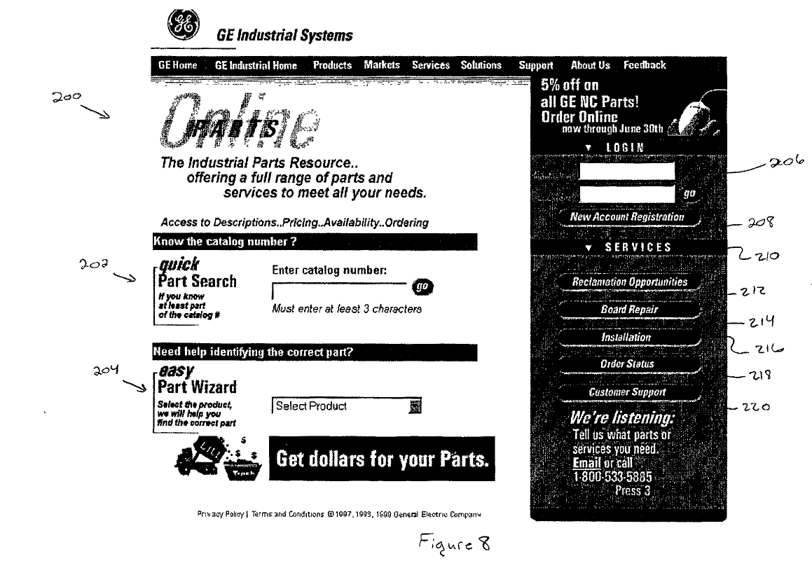

FIG. 8 is an exemplary parts online—fuses wizard entry point page 200 including a quick search area 202 and a part wizard area 204. Quick search area 202 downloads a quick search page (not shown in FIG. 8) that provides experienced users the ability to enter fuse catalog numbers and receive a picture, electrical features, web link to product information, web link to instruction book, web link to application brochure, web link to fuse outline drawing, web link to time current curves, and a fuse support and disconnect switch for the fuse catalog number. Part wizard 204 downloads a part wizard page (not shown in FIG. 8) that provides assistance to inexperienced users.

Page 200 further includes a login section 206 to be utilized by repeat users and a new account registration button 208 to be used by first time users. Page 200 also includes a services section 210 that includes a reclamation opportunities button 212, a board repair button 214, an installation button 216, an order status button 218, and a customer support button 220.

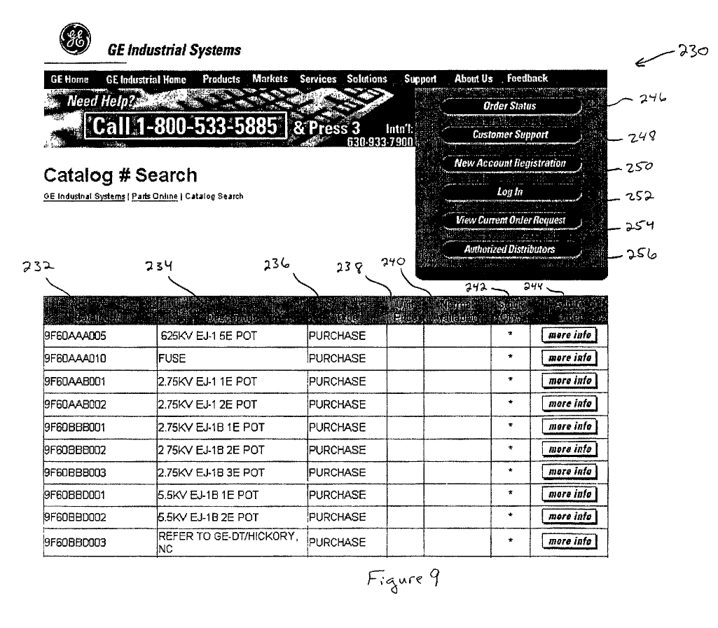

FIG. 9 is an exemplary fuses quick search page 230 including a listing of catalog numbers 232, descriptions 234, types 236, unit price 238, normal availability 240, stock quantity 242, and an add to order listing 244. In addition, quick search page 230 includes an order status button 246, a customer support button 248, a new account registration button 250, a log in button 252, a view current order request button 254, and an authorized distributors button 256.

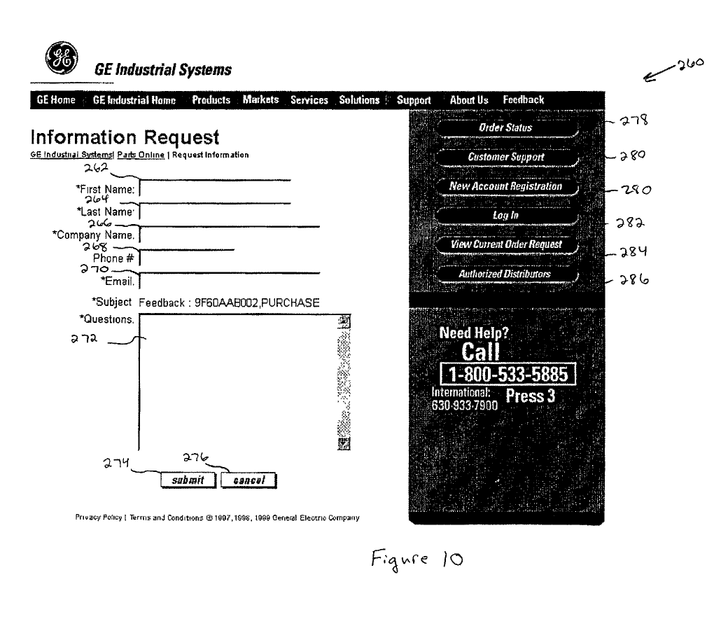

FIG. 10 is an exemplary information request page 260 including data entry blocks for first name 262, last name 264, company name 266, phone number 268, email 270, and questions 272. Page 260 also includes a submit button 274 and a cancel button 276 for submitting and canceling, respectively, the information request. Page 260 further includes an order status button 278, a customer support button 280, a new account registration button 282, a log in button 284, a view current order request button 286, and an authorized distributors button 288.

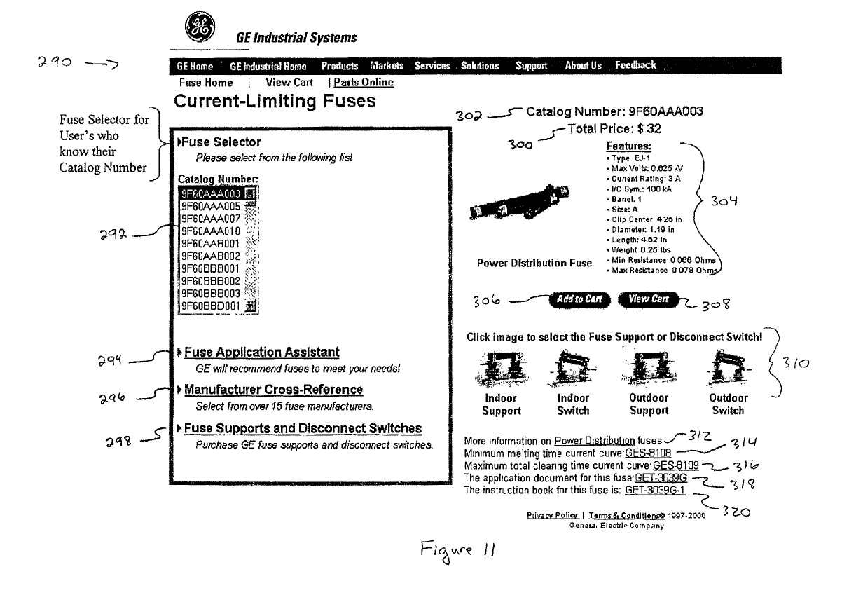

FIG. 11 is an exemplary fuse wizard main page 290 including a pull down menu 292 for catalog numbers of fuses. Page 290 also includes a fuse application assistant 294 that downloads information relating to recommended fuses to meet that user″s needs, a manufacturer cross-reference 296 that downloads information relating to compatible fuses manufactured by a variety of manufacturers, and a fuse supports and disconnect switches section 298 that downloads information relating to fuse supports and disconnect switches for the selected fuse.

A total price 300 and a catalog number 302 are displayed to the user on page 290. Page 290 also displays all selected features 304 for the indicated product. In addition, page 290 includes an Add to Cart button 306 and a View Cart button 308. A fuse support and disconnect switch section 310 include images of various configurations. Selection of one of the images orders the selected fuse support or disconnect switch. In addition, page 290 includes a more information section 312, a minimum melting time current curve section 314, a maximum total clearing time current curve section 316, an application document section 318, and an instruction book section 320.

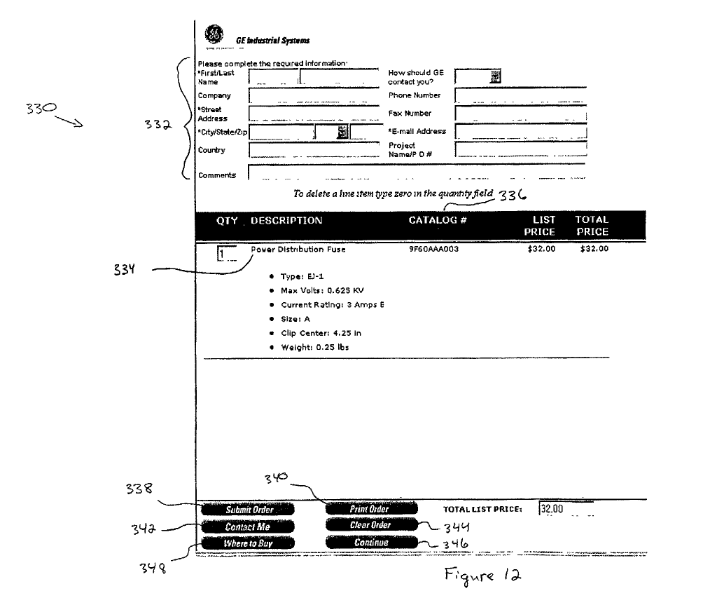

If the user selects Add to Cart button 306, an output form page (not shown in FIG. 11) is downloaded and displayed on device 14 by server 12. For example, FIG. 12 is an exemplary output form page 330 including a plurality of information blocks 332 to be completed by the user. In addition, output form page 330 includes a listing of fuses 334, including the selected features, and a listing of catalog numbers 336 for the selected fuses that the user has ordered. If the user is a registered user, system 10 accepts an online order when the user selects a Submit Order button 338. In addition, the user prints the order by selecting a Print Order button 340.

If the user is an unregistered user, system 10 transmits a notification (not shown) to the user, as explained above. Alternatively, the user selects a Contact Me button 342 that transmits a notification to an appropriate person with the business entity that the requesting user would like to be contacted regarding the purchase.

Still further, the user selects a Clear Order button 344 to clear the listed orders from the screen or the user selects a Continue button 346 to close output form page 330 and send the user back to the page before the output form page. In a further alternative embodiment, the user selects a Where to Buy button 348 to provide a listing of businesses and locations of the businesses that sell the requested fuse and any related products.

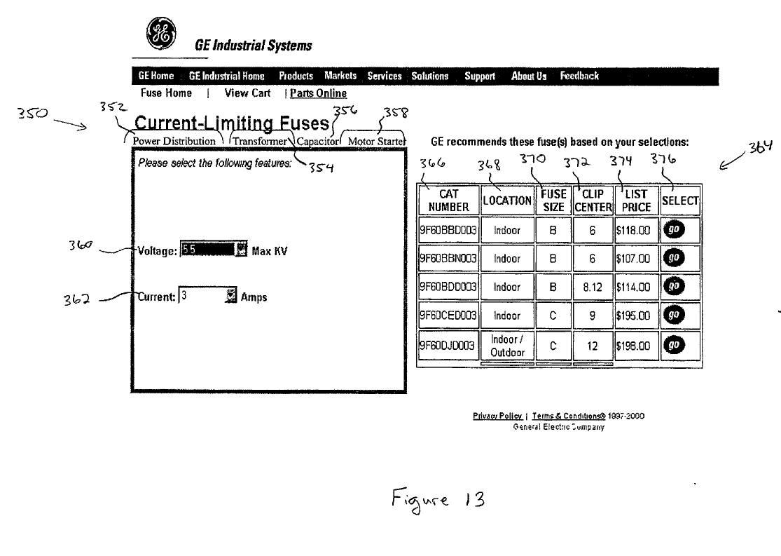

FIG. 13 is an exemplary application assistant page 350 for current limiting fuses including a power distribution tab 352, a transformer tab 354, a capacitor tab 356, and a motor starter tab 358. On page 350, capacitor tab 356 has been selected and pull down menus for voltage 360 and current 362 are available for selection by the user. In addition, a recommendation section 364 includes a catalog number 366, a location 368, a fuse size 370, a center clip 372, a list price 374, and a select button 376. Recommendation section 364 recommends fuses for different applications selected by the user. The recommendations permit a user to select a fuse which meet the user″s criteria.

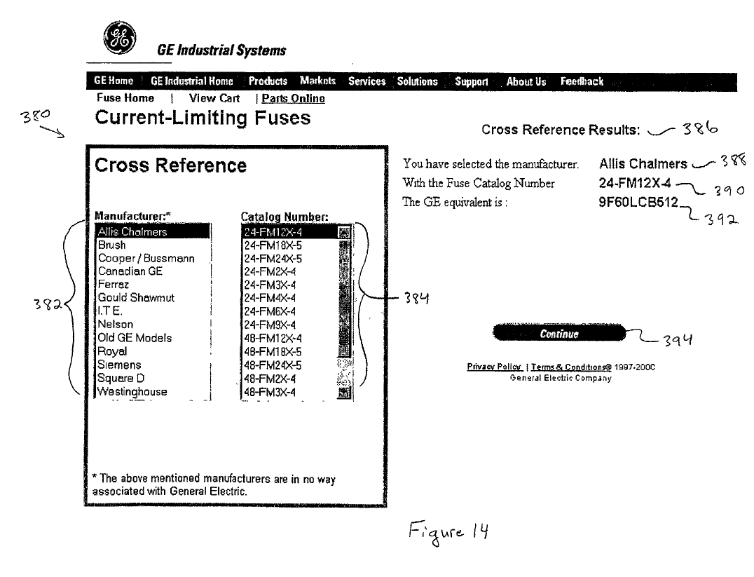

FIG. 14 is an exemplary manufacture cross reference page 380 including a listing 382 of a variety of manufacturers and a listing 384 of catalog numbers for products manufactured by the listed manufacturers. Additionally, page 380 includes a results section 386 that lists the selected manufacturer 388, the selected fuse catalog number 390, and an equivalent fuse 392 manufactured by, or at the direction of, the business entity that is managing page 380. Page 380 also includes a Continue button 394 that takes the user back to the previous page.

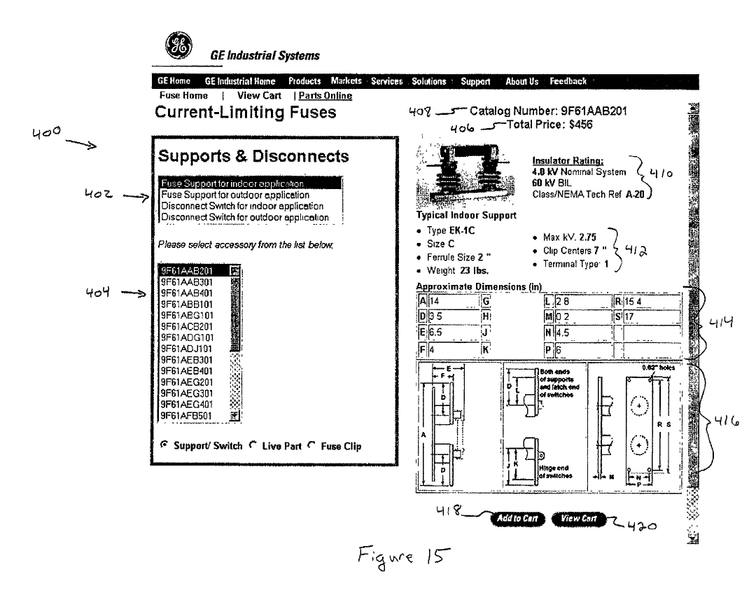

FIG. 15 is an exemplary support and disconnect selector page 400 including a supports and disconnects section 402 and an accessory section 404. Supports and disconnects section 402 lists a variety of supports and disconnects and accessory section 404 lists accessories to be used with the selected supports and disconnects. An updated total price 406 and an updated catalog number 408 are displayed to the user. Page 400 also displays an insulator rating 410 and all selected features 412. Additionally, page 400 displays the approximate dimensions 414 of the selected support or disconnect switch as well as schematic views 416 of the selected support or disconnect. Further, the user has the option of selecting an Add to Cart button 418 or a View Cart button 420.

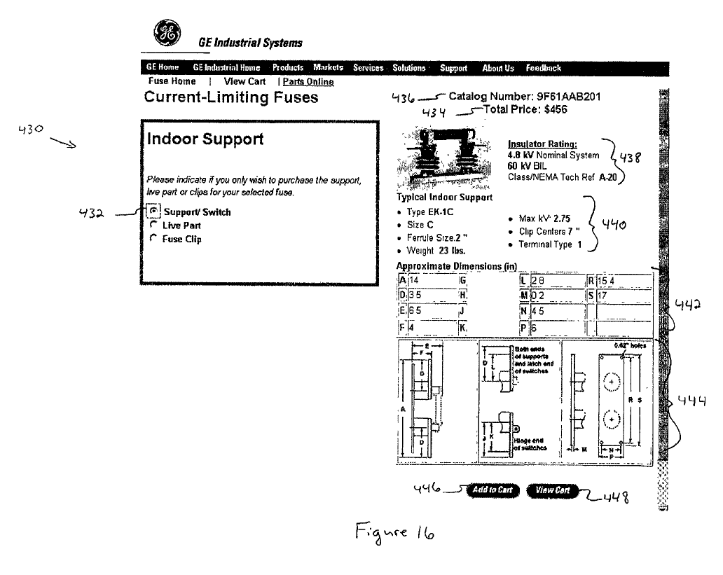

FIG. 16 is an exemplary fuse accessories page 430 having a support/switch box 432 selected. An updated total price 434 and an updated catalog number 436 are displayed to the user. Page 430 also displays an insulator rating 438 and all selected features 440. Additionally, page 430 displays the approximate dimensions 442 of the selected support or disconnect switch as well as schematic views 444 of the selected support or disconnect. Further, the user has the option of selecting an Add to Cart button 446 or a View Cart button 448.

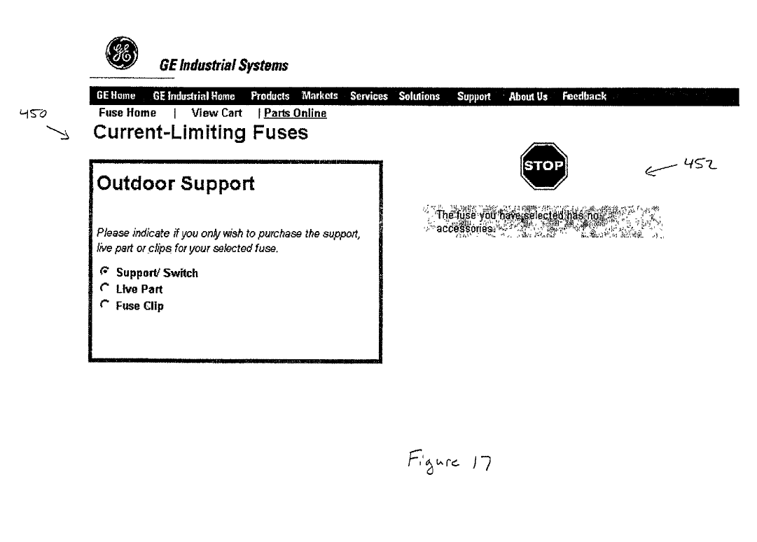

FIG. 17 is an exemplary guidance message page 450 illustrating a message 452 transmitted by system 10 (shown in FIG. 1) if the selected fuse entered by the user has no accessories, live parts, or fuse clips. In an alternative embodiment, an other messages page (not shown) is displayed by system 10 when an accessory is suggested to be used with the selected fuse. The other messages page includes a message (not shown) that indicates a certain accessory is suggested for use with the selected fuse.

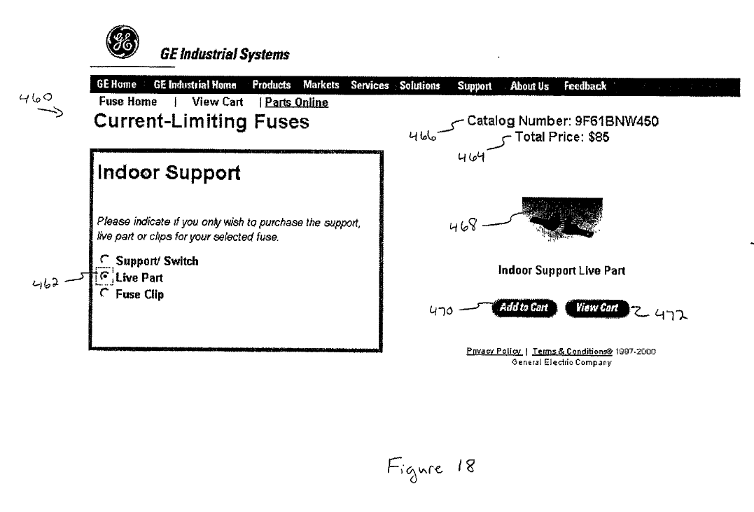

FIG. 18 is an exemplary live parts selector page 460 having a live part box 462 selected. An updated total price 464 and an updated catalog number 466 are displayed to the user. Page 460 also displays an image 468 of the selected live part. Further, the user has the option of selecting an Add to Cart button 470 or a View Cart button 472.

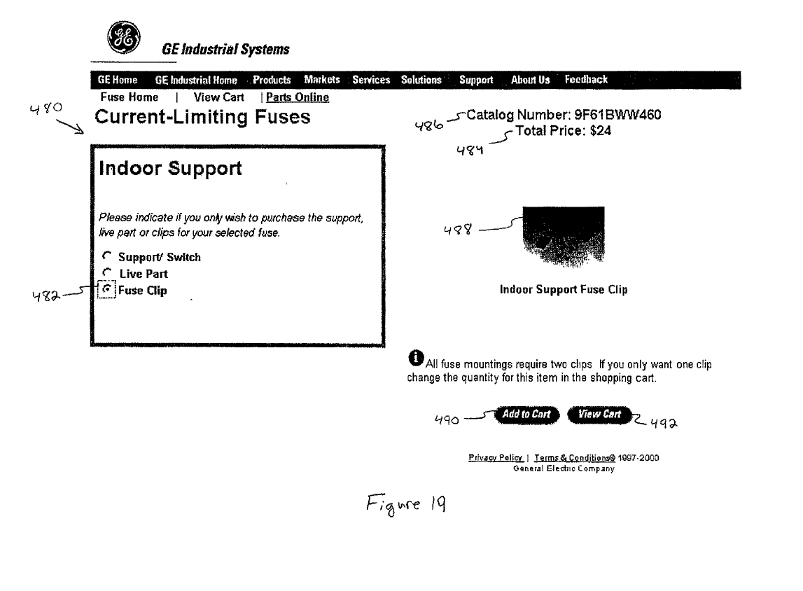

FIG. 19 is an exemplary live parts selector page 480 having a fuse clip box 482 selected. An updated total price 484 and an updated catalog number 486 are displayed to the user. Page 480 also displays an image 488 of the selected fuse clip. Further, the user has the option of selecting an Add to Cart button 490 or a View Cart button 492.

System 10 facilitates an easy and efficient method for identifying and ordering transformers. System 10 is network based and is configured to permit users to access system 10 from remote locations through devices 14.

While the invention has been described in terms of various specific embodiments, those skilled in the art will recognize that the invention can be practiced with modification within the spirit and scope of the claims.

1] A method for facilitating selection of a fuse for a product using a web-based system including a server and at least one device connected to the server via a network, said method comprising the steps of:
receiving product specification information from a user via the device;
comparing the received product specification information with pre-stored fuse information;
selecting at least one fuse which matches the received product specification information; and
downloading information related to the fuse.

2] A method according to claim 1 wherein said step of receiving product specification information comprises the step of receiving at least one of fuse features information, capacitor fuse information, motor starter fuse information, fuse supports information, accessory information, and fuse disconnects information for the product.

3] A method according to claim 1 wherein said step of receiving product specification information comprises the step of receiving fuse information including at least one of voltage, current, manufacturer and catalog number.

4] A method according to claim 1 wherein said step of receiving product specification information for the product comprises the steps of:
receiving a voltage and a current; and
providing at least one of a catalog number, a location, a fuse size, a clip center dimension, and a list price.

5] A method according to claim 1 wherein said step of receiving product specification information for the product comprises the steps of:
receiving a manufacturer and a catalog number; and
providing a catalog number for an equivalent fuse.

6] A method according to claim 2 wherein said step of comparing the received product specification information comprises the steps of: determining whether the fuse includes any accessories; and
displaying a message if the selected fuse does not include any accessories and an accessory is selected.

7] A method according to claim 2 wherein said step of downloading information related to the fuse comprises the step of downloading at least one of features for the product, accessories for the product,
recommendations for the product, a fuse catalog number and list price for the product and a quotation for the fuse.

8] A method according to claim 1 wherein said step of selecting a fuse comprises the step of selecting a fuse based on at least one of a catalog number, location, fuse size, clip center dimension, and price.

9] A method according to claim 7 further comprising the step of providing a table of fuses that meets the received product specification information.

10] A method according to claim 7 further comprising the step of guiding the user, if the resulting product does not meet the parameters of the product, to a correct product configuration.

11] A method according to claim 7 further comprising the step of guiding the user to a compatible product.

12] A system for facilitating selection of a fuse, said system comprising:
a device; and
a server connected to said device and configured to receive fuse information data from a user via said device, the fuse information including at least one of a feature of the fuse and an accessory of the fuse, said server further configured to identify stored fuse information data that matches the fuse information data entered by the user.

13] A system according to claim 12 wherein said server further configured to select at least one fuse from the stored fuse information data which matches the fuse identification data entered by the user.

14] A system according to claim 12 wherein said server further configured to select, from the stored fuse information data which matches the fuse identification data entered by the user, at least one of a fuse support, a fuse disconnect and a general purpose fuse.

15] A system according to claim 12 wherein said server further configured to provide information relating to a catalog number for an equivalent fuse.

16] A system according to claim 12 wherein said server further configured to:
determine whether the fuse includes any accessories; and
display a message if the selected fuse does not include any accessories and an accessory is selected.

17] A system according to claim 12 wherein said server further configured to accept a purchase order for the fuse after the purchase order has been authenticated against pre-determined criteria.

18] A system according to claim 12 wherein said device configured to be a server for a network of customer devices.

19] A system according to claim 12 wherein said server and said device are connected via at least one of a wide area network, a local area network and the Internet.

20] A system according to claim 12 wherein said server further configured to receive at least one of medium voltage current limiting, medium voltage expulsion, and low voltage product specification information from the user.

21] A computer programmed to:
prompt a user to select a fuse;
prompt a user to provide information required to generate a fuse
recommendation for the product; and
generate a recommendation using the user provided information.

22] A computer in accordance with claim 21 wherein to prompt a user to select a fuse, said computer displays a computer generated screen listing a plurality of at least one of features for the product, accessories for the product, recommendations for the product, a fuse catalog number and list price for the product and a quotation for the fuse.

23] A computer in accordance with claim 21 wherein to prompt a user to provide information required to generate a fuse recommendation, said computer displays a computer generated screen listing a plurality of information boxes.

24] A computer in accordance with claim 21 further programmed to search a database to identify fuses which match criteria supplied by the user in response to prompting the user to provide information required to generate the recommendation and to display to the user at least some information relating to at least one fuse identified as a match from the database search.

25] A computer in accordance with claim 21 further programmed to prompt a user to select at least one of the identified fuses, and wherein to generate the fuse recommendation, said computer populates the document with data related to the one identified fuse.

26] A computer in accordance with claim 21 further programmed to:
determine whether the fuse includes any accessories; and
display a message if the selected fuse does not include any accessories and an accessory is selected.

27] A computer in accordance with claim 21 further programmed to guide the user, if the resulting product does not meet the parameters of the product, to a correct product configuration.

28] Apparatus comprising:
means for prompting a user to select a fuse;
means for prompting the user to provide information regarding the selected fuse; and
means for transmitting to the user a recommendation for a particular fuse.

29] Apparatus in accordance with claim 28 wherein said means for prompting a user to select a fuse comprises means for displaying a computer generated screen listing a plurality of at least one of fuse features selections, capacitor fuse selections, motor starter fuse selections, fuse supports selections, fuse accessory selections, fuse disconnects selections, and general purpose fuse selections.

30] Apparatus in accordance with claim 29 wherein said means for prompting a user to provide information comprises means for displaying a computer generated screen listing at least one of features, application, accessories, and options.

31] Apparatus in accordance with claim 29 further comprising means for searching a database to identify fuses which match criteria supplied by the user in response to prompting the user to provide information regarding the selected fuses, and means for displaying to the user at least some information relating to at least one fuse identified from the database search.

32] A computer program embodied on a computer readable medium for selecting fuses for a particular application, said computer program comprising:
a code segment that receives information received from a user;
a code segment that compares the received product specification information with pre-stored fuse information and selects at least one fuse which matches the received product specification information; and
a code segment that downloads information related to the selected fuse.

33] The computer program as recited in claim 32 wherein the code segment that compares the received product specification information determines whether the fuse includes any accessories and displays a message if the selected fuse does not include any accessories and an accessory is selected.

34] The computer program as recited in claim 32 further comprising a code segment that accepts a purchase order for the fuse after the purchase order has been authenticated against pre-determined criteria.

35] The computer program as recited in claim 32 further including a code segment that guides the user, if the resulting product does not meet the parameters of the product, to a correct product configuration.
